(19) United States
(12) Patent Application Publication
(10) Pub. No.: US 2012/0062120 A1
(43) Pub. Date: Mar. 15, 2012

(54) THERMAL FOLDBACK CIRCUIT WITH DIMMER MONITOR

(76) Inventor: Scott A. Riesebosch, St. Catharines (CA)

(21) Appl. No.: 12/881,764

(22) Filed: Sep. 14, 2010

(51) Int. Cl. H01J 61/52; H05B 41/36

(52) U.S. Cl. 315/117; 315/291; 315/112

(57) ABSTRACT

A thermal foldback circuit protects a lamp circuit component from overheating by limiting power to the lamp in response to an over-temperature condition. The amount of limiting is adjusted based at least in part on an input from an external power-reduction source, such as a dimmer.

### TECHNICAL FIELD

Embodiments of the invention generally relate to thermal control in lighting elements and, more particularly, to thermal foldback circuits that adjust a lighting element power level.

### BACKGROUND

A thermal foldback circuit may be used to protect a lamp and/or (in the case some low-voltage lamps) a lamp ballast from overheating. A thermal sensor monitors the temperature of a circuit element susceptible to overheating (e.g., the lamp or a heat sink) and converts the temperature to a current or voltage. The thermal foldback circuit compares the converted signal to a threshold and, if the threshold is reached, lowers the power supplied to the lamp or lamp ballast accordingly. The lowered power level results in less power consumed, and less heat produced, by the circuit element. Once the monitored temperature returns to a level safely below the threshold, the thermal foldback circuit restores the power level supplied to the lamp or lamp ballast.

Some thermal foldback circuits reduce the power level to a fixed percentage in the event of an over-temperature condition, while others may vary the percentage of the decrease in the power level in accordance with the magnitude of the over-temperature condition. Still other prior-art thermal foldback circuits may reduce the power level even if an over-temperature condition occurs when a dimmer is already reducing the supplied power. These types of thermal foldback circuits, however, lack the ability to control absolute power levels (e.g., 1 W, 5 W, 10 W) and instead reduce the power by a percentage of the nominal power output (e.g., 50%, 75%).

Indeed, significant complications can arise when a thermal foldback circuit is used in conjunction with a dimmer. If a user adjusts the dimmer to dim the lamp at the same time the thermal foldback circuit is active and reducing the supplied power, the unrelated sources of power reduction are deleteriously additive. The thermal foldback circuit, incapable of recognizing the lower absolute voltage produced by the dimmer, continues to reduce the supply voltage by the fixed percentage—correctly responding to the still-existing over-temperature condition, but failing to recognize the externally imposed power reduction. The combination of the two actions—dimming and thermal foldback—may reduce the power level in the lamp circuit to a degree sufficient to cause flickering in the lamp. A need exists for a way to prevent this undesirable flicker from occurring.

### SUMMARY

In general, various aspects of the systems and methods described herein relate to thermal foldback that protects a lamp circuit component from overheating while preventing flickering in the lamp due to a low-power condition. Thermal foldback circuits in accordance with the invention are responsive to external sources of power reduction, such as a dimmer switch. Embodiments of the invention monitor the dimmer circuit and adjust the amount of thermal limiting accordingly. If the dimmer circuit increases the amount of dimming in the lamp (thereby reducing the supplied power), the thermal foldback circuit may decrease the amount of thermal limiting applied, even if an over-temperature condition persists.

In general, in one aspect, a method for protecting a lamp circuit from overheating includes limiting power to a lamp in response to an over-temperature condition in a lamp circuit component. The amount of limiting is adjusted based at least in part on a power reduction imposed on the lamp by an external source.

In various embodiments, the external source is a dimmer and the limiting is adjusted based on an input from the dimmer. Adjusting the amount of limiting may include decreasing the amount of limiting. The input from the dimmer may be a change (and/or rate of change) in a dimmer setting. The over-temperature condition may be sensed by a thermal sensing circuit. The limiting may be decreased notwithstanding persistence of the over-temperature condition. The lamp circuit component may include a lamp, LED, heatsink, and/or lamp ballast.

In another aspect, a system for protecting a lamp circuit including a dimmer from overheating. A thermal sensor detects a temperature of a lamp circuit component, and a thermal foldback circuit limits power to a lamp in response to the detected temperature increasing past a threshold. The thermal foldback circuit decreases the amount of limiting in response to an input from the dimmer. In various embodiments, the input from the dimmer is a change (and/or a rate of change) in a dimmer setting. The lamp circuit component may be a lamp, LED, heatsink, and/or lamp ballast, and the lamp may be an Edison-based, LED, or halogen lamp.

In general, in yet another aspect, a circuit protects a lamp circuit from overheating. A thermal evaluation circuit compares a temperature signal to a threshold and produces a thermal limiting signal based thereon, and an override circuit modifies the thermal limiting signal based at least in part on an external source of power reduction. An output circuit produces a power supply control signal based at least in part on the modified thermal limiting signal. In various embodiments, the external source is a dimmer providing a signal representative of a degree of dimming. The thermal evaluation circuit may include a comparator, and input from the dimmer may be a change (and/or rate of change) in a dimmer setting.

In still another aspect, a circuit for protecting a lamp circuit from overheating includes a thermal evaluation circuit for sensing an over-temperature condition in the lamp circuit. A thermal foldback circuit reduces power to the lamp circuit in response to the sensed over-temperature circuit; in response to an external source of power reduction, the thermal foldback circuit modifies the power reduction signal. In various embodiments, the external source is a dimmer. The thermal foldback circuit may be responsive to a change (and/or rate of change) in a setting of the dimmer.

### BRIEF DESCRIPTION OF THE DRAWINGS

In the drawings, like reference characters generally refer to the same parts throughout the different views. In the following description, various embodiments of the present invention are described with reference to the following drawings, in which:

FIG. 1 is a block diagram illustrating a thermal foldback circuit having a dimmer control in accordance with an embodiment of the invention; and

FIG. 2 is a flowchart illustrating a method for modifying the operation of a thermal foldback circuit in accordance with an input received from a dimmer.

### DETAILED DESCRIPTION

Described herein are various embodiments of methods and systems for a thermal foldback circuit for protecting a lamp circuit component from overheating while preventing flickering in the lamp due to a low-power condition. In various embodiments, the thermal foldback circuit monitors an input from a dimmer circuit and adjusts its amount of thermal limiting accordingly. If the dimmer circuit increases the amount of dimming in the lamp (by reducing the supplied power), the thermal foldback circuit may decrease the amount of thermal limiting applied, even if an over-temperature condition persists.

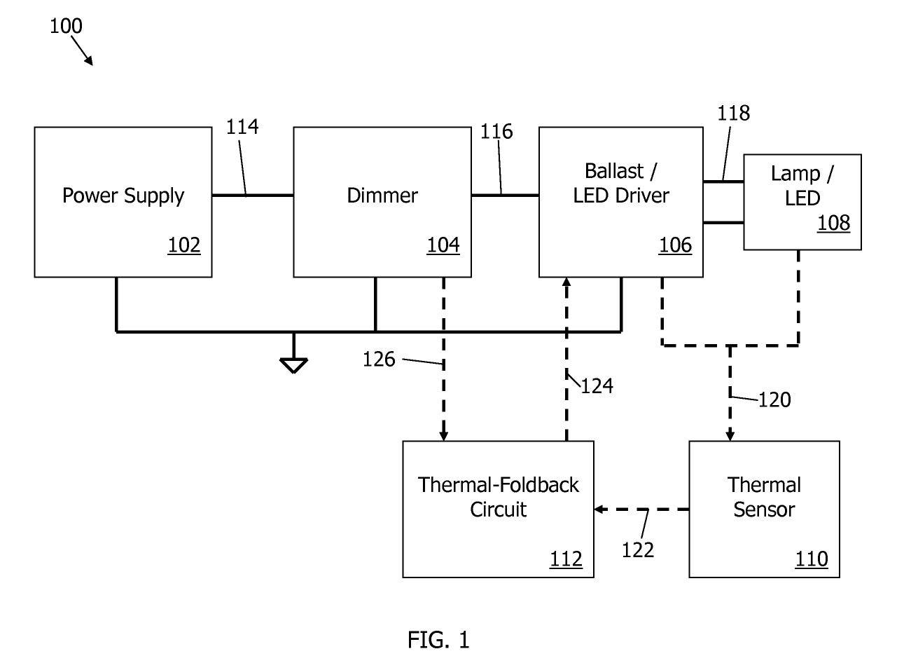

FIG. 1 illustrates a lamp control circuit 100 in accordance with an embodiment of the invention. A power supply 102 provides a voltage source 114 for the circuit. The power supply 102 may be a mains supply (suitable for, e.g., Edison-based lamps) or include a step-down transformer (suitable for low-voltage lamps such as light-emitting diodes (LEDs) or halogen lights). A dimmer 104 controls the supply of power 114 from the power supply 102 in accordance with a user request. The dimmer 104 may include a user input mechanism, such as a rotatable mechanical knob or slider or an electronic control, for specifying the amount of dimming. In one embodiment, the dimmer 104 allows approximately 100% of the supply voltage 114 to pass when the user input mechanism is in an “ON” or “no dimming” position; when the user input mechanism is in an opposite position, the dimmer 104 may either restrict most or all of the power supply voltage 114 from passing or may allow a minimum voltage to pass. Between the two positions, the amount of power restricted may be a linear or nonlinear function of dimmer position, reflecting the output characteristics of the lamp.

An LED driver or ballast 106 receives the modified power supply voltage 116 from the dimmer 104. The LED driver/ballast 106 may include a driver circuit for supplying a drive current to a lamp/LED 108 and/or a series resistor, switched network, or any other type of ballast circuit known in the art. The LED driver/ballast 106 provides a voltage and/or current 118 to the lamp 108; the voltage or current is appropriate for the voltage and/or current requirements of the lamp 108. For example, if the lamp 108 is an LED, the ballast LED driver/106 may provide a voltage 118 sufficient to light the lamp/LED 108 while preventing it from drawing too much current and thereby damaging itself. In one embodiment, the minimum voltage level provided by the dimmer 104 is calibrated (at a low temperature) to be the minimum voltage level at which the lamp 108/LED remains barely lit. It should be noted that, in certain embodiments, the lamp 108 does not require a ballast 106.

A thermal sensor 110 monitors the temperature of a circuit element in the LED driver/ballast 106, lamp/LED 108, and/or other part of the lamp control circuit 100. The thermal sensor 110 may be any temperature-based sensor known in the art (based on a thermistor or a thermocouple, for example), may measure temperature directly or indirectly, and may do so by direct or indirect contact with a targeted circuit element. The thermal sensor 110 converts the sensed temperature 120 or temperature-dependent parameter to a measureable signal 122, such as a voltage or current level. The thermal foldback circuit 112 receives the temperature-based signal 122 and provides a control signal 124 to the LED driver/ballast 106. If the temperature-based signal 122 exceeds a threshold, the thermal foldback circuit 112 reduces the LED driver/ballast 106 output power accordingly, via the control signal 124, until the temperature-based signal 122 recedes below the threshold.

In one embodiment, the thermal foldback circuit 112 receives a dimmer status signal 126 from the dimmer 104. Based on the current setting of the dimmer 104 (and/or recent changes thereto), or the temperature level 122, the thermal foldback circuit 112 changes its behavior. More specifically, if the thermal foldback circuit 112 is engaged and instructing or causing the power supply 102 to reduce its output power by a certain percentage, and if the dimmer status signal 126 indicates a drop in the setting of the dimmer 104, the thermal foldback circuit 112 reduces the degree to which it causes power to the lamp 108 to be limited, as explained further below.

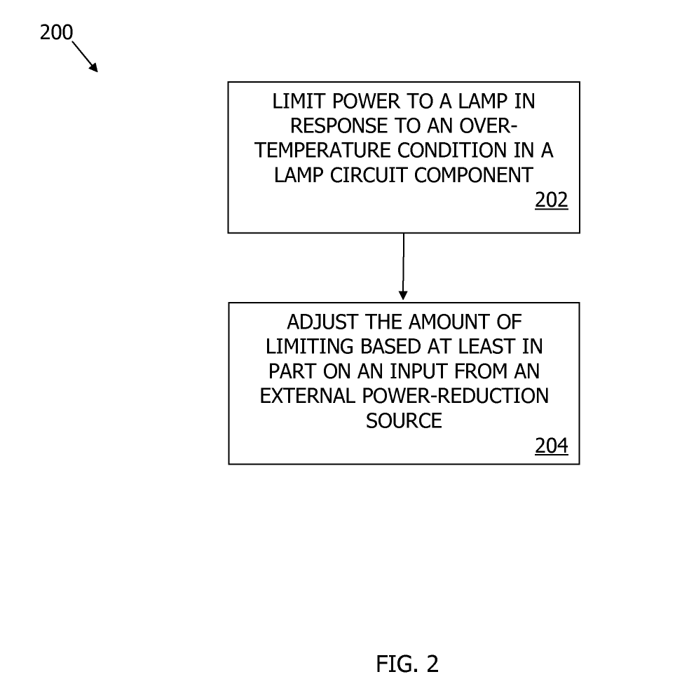

FIG. 2 illustrates a method for protecting a lamp circuit from overheating. In summary, the power supplied to a lamp is limited in response to an over-temperature condition in a lamp circuit component (Step 202). The thermal limiting is decreased based at least in part on an input from a dimmer (Step 204).

With reference to Step 202, in greater detail, the thermal foldback circuit 112 limits the power output of the power supply 102 in accordance with a temperature sensed by the thermal sensor 110. If an element in the LED driver/ballast 106 or lamp/LED 108 gets too hot (i.e., an over-temperature condition), the thermal foldback circuit 112 reduces the power supply until the element starts to cool. Once the element cools sufficiently, the thermal foldback circuit 112 partially or wholly restores the power. If an over-temperature condition again arises, the thermal foldback circuit 112 restarts the process, limiting power until the temperature has fallen below the over-temperature threshold. In one embodiment, the over-temperature condition arises only when the power supplied to the lamp/LED 108 is at or near maximum power.

The element in the LED driver/ballast 106 or lamp/LED 108 experiencing the over-temperature condition may, however, respond slowly to changes in applied power. That is, some time may elapse between the application of a high power to the LED driver/ballast 106 or lamp 108 and the emergence of an over-temperature condition, and, likewise, a further span of time at reduced power may be required before the affected element cools significantly. Either of these hysteretic spans of time may be longer than the time it takes for the dimmer 104 to produce a change in the power level. The combination of temperature hysteresis and arbitrary dimmer adjustments may lead to the flickering condition described above.

For example, the maximum output wattage 114 of the power supply 102 may be 10 W. This high wattage level may cause an over-temperature condition of, say, 150° C. in the lamp/LED 108. The thermal foldback circuit responds and reduces the power supply power 144 by 50%, so the lamp 108 receives 5 W. Before the lamp/LED 108 cools down from 150° C., however, the dimmer 104 is adjusted to transition from 0% dimming to 50% dimming. Because the over-temperature condition still exists, a fixed thermal foldback circuit 112 would still limit the power supply output by 50%, causing the power delivered to the lamp 108 to be 25% of its maximum value, or 2.5 W. This power may be lower than a minimum power or voltage required to operate some or all of the lamp circuit components (such as the lamp/LED 108, LED driver/ballast 106, dimmer 104, a transformer in the power supply 102, or any other component with a minimum load requirement) and may thus cause flickering in the lamp/LED 108.

In Step 204, in order to prevent this condition, the thermal limiting is decreased based at least in part on an input from the dimmer 104, which reflects the current degree of dimming (if any). If the dimmer 104 is changed to increase the amount of dimming, the thermal foldback circuit 112 responds by decreasing the amount of thermal limiting currently being applied to the power supply 102 (if any). The thermal foldback circuit 112 thus prevents the voltage applied to the lamp/LED 108 or other circuit element from falling to an artificially and unnecessarily low level due to the combination of thermal and dimmer voltage limiting.

In one embodiment, the thermal foldback circuit 112 reduces the amount of thermal limiting even if the over-temperature condition still persists. Before the dimmer changes, the thermal foldback circuit 112 may have already decreased the voltage applied to the lamp/LED 108 to a percentage sufficient to protect the lamp/LED 108 (or other lamp circuit component) from an over-temperature condition. Operation of the dimmer 104, however, may decrease the voltage applied to the lamp/LED 108 still further. At this lower voltage, the thermal foldback circuit 112 is restricting the lamp voltage more than what is necessary to thermally protect the lamp circuit component. The thermal foldback circuit 112 may therefore be adjusted to reduce the amount of limiting current applied without harming the lamp circuit component even if the over-temperature condition still exists. In other words, the thermal foldback circuit establishes a reduced power target to the lamp in response to the sensed temperature condition, and if power limiting from an external source (such as a dimmer switch) is detected, the thermal foldback circuit adjusts its own degree of power limiting to ensure that the power actually reaching the lamp does not fall below the power target.

To illustrate this process, continuing from the above example, the thermal foldback circuit 112 limits the voltage of the power supply 102 by 50% (i.e., restricts the lamp voltage to 5 V) in response to the over-temperature condition of 150° C. In response to the dimmer input, which produces a transition from 0% dimming to 50% dimming, the thermal foldback circuit 112 lowers its level of thermal limiting from 50% to 25%, even though the lamp/LED 108 is still at 150° C. Thus, the resulting voltage at the lamp/LED 108 is 3.75 V (instead of 2.5 V, as above), which may be sufficiently high to prevent flicker in the lamp/LED 108. Thus, even though the level of thermal limiting is reduced, the resulting voltage applied to the lamp/LED 108 (3.75 V) remains less than the voltage originally applied to the lamp/LED 108 (5 V) in response to the over-temperature condition. In other examples, the resulting voltage may be greater or less than 3.75 V, but remains above a minimum voltage required to prevent the circuit 100 from causing flickering in the lamp 108 and below a maximum voltage that would damage the lamp/LED 108.

The thermal foldback circuit 112 may respond to either a change in a setting of the dimmer 104 or a rate of change in the setting of the dimmer 104. In one embodiment, if the current setting of the dimmer 104 produces a greater amount of dimming than a previous setting, the increased dimming is detected by the thermal foldback circuit 112 and the amount of thermal limiting is decreased by a corresponding amount. The reduction in thermal limiting may be proportionate to the increase in dimming or may have a nonlinear relationship with the increase in dimming, depending on the characteristics of the lamp and the relationship between applied power and operating temperature. In one embodiment, the reduction in the amount of thermal limiting is calibrated to allow the dimmer 104 to dim the lamp 108 during an over-temperature condition yet still protect the lamp control circuit 100 from low-voltage flicking. In other words, if the reduction in thermal limiting is too aggressive, it may wash out the effects of the dimmer 104 entirely, and a change in the dimmer 104 will not affect the brightness of the lamp/LED 108. If the reduction in thermal limiting is not aggressive enough, the voltage to the lamp/LED 108 or other lamp circuit component will fall below a minimum required to avoid flicker.

In another embodiment, the thermal foldback circuit 112 responds to the rate of change in the setting of the dimmer 104. For example, if the dimmer 104 is changing very slowly or very quickly, the thermal foldback circuit 112 may adjust the amount of thermal limiting to a greater or lesser degree. A slow change in the dimmer 104 may keep pace with a temperature change in a lamp component, and, therefore, a corresponding adjustment in the amount of thermal limiting may be less than otherwise required (or even unnecessary). A fast change in the dimmer 104, however, may require a greater degree of thermal adjustment to quickly boost a lamp voltage and prevent flickering. Early detection of a fast rate of change may allow the thermal foldback circuit 112 to boost the lamp voltage in anticipation of an eventual large absolute change, even though the magnitude of the absolute change is not yet known.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

What is claimed is:

1. A method for protecting a lamp circuit from overheating, the method comprising:
limiting power to a lamp in response to an over-temperature condition in a lamp circuit component;
adjusting the amount of limiting based at least in part on a power reduction imposed on the lamp by an external source.

2. The method of claim 1, wherein the external source is a dimmer and the limiting is adjusted based on an input from the dimmer.

3. The method of claim 1, wherein adjusting the amount of limiting comprises decreasing the amount of limiting.

4. The method of claim 1, wherein the input from the dimmer comprises a change in a dimmer setting.

5. The method of claim 1, wherein the input from the dimmer comprises a rate of change in a dimmer setting.

6. The method of claim 1, wherein the over-temperature condition is sensed by a thermal sensing circuit.

7. The method of claim 1, wherein the limiting is decreased notwithstanding persistence of the over-temperature condition.

8. The method of claim 1, wherein the lamp circuit component comprises at least one of a lamp, LED, heatsink, or lamp ballast.

9. A system for protecting a lamp circuit including a dimmer from overheating, the system comprising:
a thermal sensor for detecting a temperature of a lamp circuit component; and
a thermal foldback circuit for limiting power to a lamp in response to the detected temperature increasing past a threshold, the thermal foldback circuit decreasing the amount of limiting in response to an input from the dimmer.

10. The system of claim 9, wherein the input from the dimmer comprises a change in a dimmer setting.

11. The system of claim 9, wherein the input from the dimmer comprises a rate of change in a dimmer setting.

12. The system of claim 9, wherein the lamp circuit component comprises at least one of a lamp, LED, heatsink, or lamp ballast.

13. The system of claim 9, wherein the lamp comprises an Edison-based lamp.

14. The system of claim 9, wherein the lamp comprises one of an LED or a halogen lamp.

15. A circuit for protecting a lamp circuit from overheating, the circuit comprising:
a thermal evaluation circuit for comparing a temperature signal to a threshold and for producing a thermal limiting signal based thereon;
an override circuit for modifying the thermal limiting signal based at least in part on an external source of power reduction; and
an output circuit for producing a power supply control signal based at least in part on the modified thermal limiting signal.

16. The circuit of claim 15, wherein the external source is a dimmer providing a signal representative of a degree of dimming.

17. The circuit of claim 15, wherein the thermal evaluation circuit comprises a comparator.

18. The circuit of claim 16, wherein the input from the dimmer comprises a change in a dimmer setting.

19. The circuit of claim 16, wherein the input from the dimmer comprises a rate of change in a dimmer setting.

20. A circuit for protecting a lamp circuit from overheating, the circuit comprising:
a thermal evaluation circuit for sensing an over-temperature condition in the lamp circuit;
a thermal foldback circuit for reducing power to the lamp circuit in response to the sensed over-temperature circuit, the thermal foldback circuit being responsive to an external source of power reduction and modifying the power reduction signal based thereon.

21. The circuit of claim 20, wherein the external source is a dimmer.

22. The circuit of claim 21, wherein the thermal foldback circuit is responsive to a change in a setting of the dimmer.

23. The circuit of claim 21, wherein the thermal foldback circuit is responsive to a rate of change in a setting of the dimmer.
